(19) United States
(12) Patent Application Publication
(10) Pub. No.: US 2014/0309367 A1
(43) Pub. Date: Oct. 16, 2014

(54) Use of a polyamide chain-extending compound as a stabilizer

(71) Applicant: Gerard Bradley, Brindas (FR)

(72) Inventor: Gerard Bradley, Brindas (FR)

(73) Assignee: RHODIA OPERATIONS, Aubersvilliers (FR)

(21) Appl. No.: 14/232,025

(22) PCT Filed: Jul. 6, 2012
(86) PCT No.: PCT/EP2012/063279

§ 371 Date: Jul. 2, 2014

(30) Foreign Application Priority Data
Jul. 11, 2011 (FR) 1156263

(51) Int. Cl. C08L 77/00; C08L 51/00; C08G 69/48

(52) U.S. Cl. CPC C08L 77/00; C08G 69/48; C08L 51/00
USPC 524/606; 525/420; 525/426

(57) ABSTRACT

The invention relates to the use of a polyamide chain-extending compound as an agent for stabilizing the polyamide toward heat, light and/or bad weather. Polyamide compositions may comprise at least one of these polyamide chain-extending compounds and optionally reinforcing fillers and optionally impact modifiers.

The invention relates to a polyamide that is stabilized toward heat, light and bad weather by using a polyamide chain-extending compound as an agent for stabilizing the polyamide toward heat, light and/or bad weather. The present invention also relates to polyamide compositions comprising at least one polyamide chain-extending compound and optionally reinforcing fillers and optionally impact modifiers.

Polyamide is a synthetic polymer widely used for the manufacture of various articles, such as molded and/or injection-molded parts. Polyamide can undergo degradations when it is subjected to external elements or conditions such as UV rays, heat and/or bad weather. Degradations can also be induced by the heat used during production thereof and/or forming thereof. This instability is reflected by degradations, loss of mechanical properties, and changes in color. These problems can become critical for a certain number of applications, such as, in particular, parts in the motor vehicle industry which are in particular subjected to considerable heat.

In order to improve the stability of polyamides with respect to heat, it is known practice to combine them with particular stabilizers. Many additives are sold for this purpose. The use of copper iodide, in particular in combination with potassium iodide, which is used in most cases and which provides good stabilization properties, is, for example, known. It is also known practice to use more complex additives, such as hindered phenolic antioxidant compounds, stabilizers having at least one hindered amine unit of an HALS type, or phosphorus-containing stabilizers.

However, there is a need to obtain polyamide compositions which are even more efficient in terms of stabilization toward heat, and which are less expensive.

The Applicant has developed a novel polyamide composition that makes it possible to obtain excellent maintenance of the mechanical properties after long exposure to heat, light and/or bad weather, by using a polyamide chain-extending compound as an agent for stabilizing the polyamide toward heat, light and/or bad weather. The composition obtained especially has a good compromise of mechanical and rheological properties.

The present invention thus relates to the use of a polyamide chain-extending compound as an agent for stabilizing the polyamide toward heat, light and/or bad weather. The invention also relates to a composition comprising at least the polyamide and a polyamide chain-extending compound.

The expression “agent for stabilizing the polyamide toward heat, light and bad weather” means a compound that is especially capable of maintaining a good level of mechanical properties for a polyamide composition subjected to heat, light and/or bad weather for a prolonged period.

The composition according to the invention preferentially has a retention of the tensile breaking stress of greater than or equal to 50%, measured according to standard ISO 527/1A on specimens 4 mm thick after an aging test in air at 210° C. for 1000 hours, in comparison with the same composition before the aging test.

The composition according to the invention more preferentially has a retention of the tensile breaking stress of greater than or equal to 50%, measured according to standard ISO 527/1A on specimens 4 mm thick after an aging test in air at 220° C. for 1000 hours, in comparison with the same composition before the aging test.

Even more preferentially, the composition according to the invention has a retention of the tensile breaking stress of greater than or equal to 50%, measured according to standard ISO 527/1A on specimens 4 mm thick after an aging test in air at 230° C. for 1000 hours, in comparison with the same composition before the aging test.

The composition according to the invention may also have a retention of the tensile breaking stress of greater than or equal to 50%, measured according to standard ISO 527/1A on specimens 4 mm thick after an aging test in air at 240° C. for 1000 hours, in comparison with the same composition before the aging test.

The polyamide chain-extending compounds (chain extenders) for the polyamide chain are usually capable of reacting with the amine or acid end groups of the polyamide. The chain extenders contain at least two functions that are capable of reacting with the end groups of the polyamide so as to connect two or more polyamide chains as a function of the functionality of the chain extender and of the number of reactive end groups of the polyamide and thus to increase the molar mass and the viscosity of the modified polyamide. The use of bis-lactams is in particular mentioned in patent U.S. Pat. No. 2,682,526.

Chain extenders according to the invention that may especially be mentioned include compounds chosen from the group consisting of: dialcohols, such as ethylene glycol, propanediol, butanediol, hexanediol or hydroquinone bis(hydroxyethyl) ether, bis-epoxides, such as bisphenol A diglycidyl ether, polymers bearing epoxide functions, polymers bearing anhydride functions, bis-N-acyl bis-caprolactams, such as isophthaloyl bis-caprolactam (IBC), adipoyl bis-caprolactam (ABC) or terphthaloyl bis-caprolactam (TBC), diphenyl carbonates, bisoxazolines, oxazolinones, diisocyanates, organic phosphites, such as triphenyl phosphite or caprolactam phosphite, bis-ketenimines and dianhydrides.

According to a first variant, the composition comprises a chain extender. According to a second variant, the composition comprises at least two chain extenders, and in particular it comprises two. The composition may, according to the first and second variants, comprise at least one, and in particular one, additive that participates in the heat stabilization of the composition, as defined later in the description.

Most particularly, the composition comprises a pair of chain extenders chosen from the following pairs:
bis-epoxides, such as bisphenol A diglycidyl ether, and organic phosphites, such as triphenyl phosphite or caprolactam phosphite, and
polymers bearing epoxide functions and organic phosphites, such as triphenyl phosphite or caprolactam phosphite.

The composition preferentially comprises from 0.01% to 5% by weight of polyamide chain extenders, relative to the total weight of the composition. More preferentially, the composition comprises from 0.1% to 3% by weight of polyamide chain extenders, relative to the total weight of the composition. Use may in particular be made of from 0.01% to 10% by weight of polyamide chain extenders, relative to the weight of the polyamide.

In the case in which the composition:
comprises at least one reinforcing filler, an impact modifier and/or another additive that participates in the thermal stabilization and/or
comprises at least two chain extenders,
   the composition comprises a content of polyamide chain extender(s) of greater than 1% by weight or even 2% by weight relative to the weight of the polyamide.

In addition, this content may range from 1.1% to 8% by weight, especially from 1.3% to 6% by weight or even from 1.5% to 4% by weight relative to the weight of the polyamide.

In the case in which the composition:
is free of reinforcing filler, impact modifier and/or another additive that participates in the thermal stabilization and
comprises only one chain extender,
   the composition comprises a content of polyamide chain extender(s) of greater than 2% by weight relative to the weight of the polyamide. In addition, this content may range from 2.05% to 8% by weight, especially from 2.1% to 6% by weight or even from 2.1% to 4% by weight relative to the weight of the polyamide.

The preferred chain-extending compounds are insensitive to the moisture content of the polyamide under the conditions of the polyamidation reaction and do not generate secondary products.

The resulting composition may especially comprise polyamide chains comprising covalently bonded residues of chain-extending compound, chains of polyamide not bonded with a residue of chain-extending compound and free chain-extending compounds diluted in the polyamide matrix.

The polyamide of the invention is especially chosen from the group comprising polyamides obtained via polycondensation of at least one aliphatic dicarboxylic acid with an aliphatic or cyclic or cycloaliphatic or arylaliphatic diamine, for instance PA 6.6, PA 6.10, PA 6.12, PA 10.10, PA 10.6, PA 12.12, PA 4.6, MXD6, PA 92, PA 102, or between at least one aromatic dicarboxylic acid and an aliphatic or aromatic diamine, for instance polyterephthalamides of the type such as PA 9T, PA 10T, PA 11T, PA 12T, PA 13T or PA 6T/MT, PA 6T/61, PA 6T/66, PA 66/6T, polyisophthalamides of the type such as PA 61, PA 61/6T, polynaphthalamides of the type such as PA 10N, PA 11N, PA 12N, polyaramides such as Kevlar, or a blend thereof and (co)polyamides thereof. The polyamide of the invention may also be chosen from polyamides obtained by polycondensation of at least one amino acid or lactam with itself, it being possible for the amino acid to be generated by hydrolytic opening of a lactam ring, such as, for example, PA 6, PA 7, PA 11, PA 12 or PA 13, or a blend thereof and (co)polyamides thereof. Types of copolyamide that may especially be mentioned include polyamide 6/66, polyamide 6/11, polyamide 6/12 and polyamide 11/12.

The diamines and diacids may bear heteroatoms. Mention may be made of 5-hydroxyisophthalic acid, 5-sulfoisophthalic acid or salts thereof; for instance the lithium, sodium or zinc salts.

Semicrystalline aliphatic or semiaromatic polyamides are especially preferred.

The polyamide is preferentially chosen from the group comprising: polyamide 6, polyamide 610, polyamide 66 and polyamide 66/6T.

In general, the polyamide is a semicrystalline polyamide with an apparent melt viscosity of between 0.5 and 1500 Pa·s, measured according to standard ISO 11443 at a shear rate of 1000 s⁻¹ at a temperature equal to 20° C. above the melting point of the polyamide, and preferentially between 0.5 and 1000 Pa·s.

Use may especially be made of polyamides of variable molecular weights by addition, before or during the polymerization of the polyamide monomers, or else in melt extrusion, of monomers that modify the length of the chains such as, in particular, difunctional and/or monofunctional compounds bearing amine or carboxylic acid functions that are capable of reacting with the polyamide monomers or the polyamide.

The term “carboxylic acid” means carboxylic acids and derivatives thereof, for instance acid anhydrides, acid chlorides and esters. The term “amine” means amines and derivatives thereof capable of forming an amide bond.

It is possible to use, at the start of, during or at the end of the polymerization, any type of aliphatic or aromatic monocarboxylic or dicarboxylic acid or any type of aliphatic or aromatic monoamine or diamine amine.

Use may very particularly be made of a polyamide obtained at least from adipic acid and hexamethylenediamine or from their salts, such as hexamethylenediamine adipate, which can optionally comprise various proportions of other polyamide monomers.

Polyamides according to the invention may also be obtained by blending, in particular melt blending. It is possible, for example, to blend a polyamide with another polyamide, or a polyamide with a polyamide oligomer, or else a polyamide with monomers which modify the length of the chains, such as, in particular, diamines, dicarboxylic acids, monoamines and/or monocarboxylic acids. It is possible, in particular, to add isophthalic acid, terephthalic acid or benzoic acid to the polyamide, for example at contents of approximately 0.2% to 2% by weight.

The composition of the invention may also comprise copolyamides derived in particular from the above polyamides or blends of these polyamides or (co)polyamides.

Use may also be made of branched polyamides of high melt flow, in particular obtained by blending, during polymerization, in the presence of the polyamide monomers, at least one multifunctional compound comprising at least 3 identical reactive functions of amine function or carboxylic acid function type.

Use may also be made, as polyamide of high melt flow, of a star polyamide comprising star macromolecular chains and, if appropriate, linear macromolecular chains. Polymers comprising such star macromolecular chains are described, for example, in the documents WO97/24388 and WO99/64496.

These star polyamides are in particular obtained by blending, during polymerization, in the presence of the polyamide monomers, an amino acid or lactam, such as caprolactam, at least one multifunctional compound comprising at least 3 identical reactive functions of amine function or carboxylic acid function type. The term “carboxylic acid” means carboxylic acids and derivatives thereof, for instance acid anhydrides, acid chlorides and esters. The term “amine” means amines and derivatives thereof capable of forming an amide bond.

The present invention thus relates to a process for manufacturing a composition in which at least one polyamide and a polyamide chain-extending compound are mixed together. Said compound may be added to the already-formed or partially formed polyamide, especially such as by placing in contact with oligomers of polyamide. The polyamide chain-extending compound may especially be added during the polymerization of the polyamide or as a mixture with the molten polyamide, for example by extrusion. The chain-extending compound may also be added without heating with the polyamide, followed by melting of the polyamide.

The polyamide compositions are generally obtained by mixing the various compounds, fillers and/or additives, especially the chain-extending compound, included in the composition, without heating or in the melt. The process is performed at more or less high temperature and at more or less high shear force, according to the nature of the various compounds. The compounds can be introduced simultaneously or successively. Use is generally made of an extrusion device in which the material is heated, then melted and subjected to a shear force, and conveyed. According to particular embodiments, premixes, in the melt or not in the melt, of the chain-extending compound may be prepared before preparing the final composition. It is possible, for example, to prepare a premix of the chain-extending compound in a resin, for example of the polyamide, so as to make a masterbatch.

The composition according to the invention may comprise one or more other polymers, preferably polyamides or copolyamides.

The composition according to the invention may comprise more than 20% by weight, preferentially more than 40% by weight and more preferentially more than 50% by weight of polyamide according to the invention, relative to the total weight of the composition.

The composition may also comprise at least one reinforcing or bulking filler. Reinforcing or bulking fillers are fillers conventionally used for the production of polyamide compositions. Mention may in particular be made of reinforcing fibrous fillers, such as glass fibers, carbon fibers or organic fibers, non-fibrous fillers such as particulate or lamellar fillers and/or exfoliable or non-exfoliable nanofillers, for instance alumina, carbon black, clays, zirconium phosphate, kaolin, calcium carbonate, copper, diatomaceous earths, graphite, mica, silica, titanium dioxide, zeolites, talc, wollastonite, polymeric fillers, such as, for example, dimethacrylate particles, glass beads or glass powder.

Preferably, reinforcing fibers, such as glass fibers, are in particular used. Preferentially, the fiber most widely used is glass fiber, of “chopped” type, having a diameter between 7 and 14 pm and a length of less than 5 mm. These fillers may have a surface size that ensures mechanical adhesion between the fibers and the polyamide matrix.

The composition according to the invention can comprise between 1% and 60% by weight of reinforcing or bulking fillers and preferentially between 10% and 40% by weight, relative to the total weight of the composition.

The composition according to the invention comprising the polyamide as defined above can comprise at least one impact modifier, that is to say a compound capable of modifying the impact strength of a polyamide composition. These impact modifiers preferentially comprise functional groups which react with the polyamide.

According to the invention, the term “functional groups which react with the polyamide” means groups capable of reacting or of interacting chemically with the acid or amine functions of the polyamide, in particular by covalency, ionic or hydrogen bond interaction or van der Waals bonding. Such reactive groups make it possible to ensure good dispersing of the impact modifiers in the polyamide matrix. Good dispersing is generally obtained with impact modifier particles having a mean size of between 0.1 and 2 pm in the matrix.

Use is preferentially made of impact modifiers comprising functional groups that react with the polyamide as a function of the acid or amine nature of the imbalance AEG=CEG-AEG (concentration of acid end groups CEG minus concentration of amine end groups AEG) of the polyamide. Thus, for example, if the AEG is “acid” (CEG>AEG), use will preferentially be made of reactive functional groups capable of reacting or of interacting chemically with the acid functions of the polyamide, in particular by covalency, ionic or hydrogen bond interaction or van der Waals bonding. If, for example, the AEG is “amine” (AEG>CEG), use will preferably be made of reactive functional groups capable of reacting or of interacting chemically with the amine functions of the polyamide, in particular by covalency, ionic or hydrogen bond interaction or van der Waals bonding. Use is preferentially made of impact modifiers having functional groups which react with the polyamide exhibiting a AEG of “amine” nature.

The impact modifiers may very well comprise in themselves functional groups which react with the polyamide, for example as regards ethylene/acrylic acid products (EAA).

It is also possible to add thereto functional groups which react with the polyamide, generally by grafting or copolymerization, for example for ethylene/propylene/diene (EPDM) grafted with maleic anhydride.

Use may be made, according to the invention, of impact modifiers which are oligomeric or polymeric compounds comprising at least one of the following monomers or a mixture thereof: ethylene, propylene, butene, isoprene, diene, acrylate, butadiene, styrene, octene, acrylonitrile, acrylic acid, methacrylic acid, vinyl acetate, vinyl esters, such as acrylic and methacrylic esters and glycidyl methacrylate. These compounds according to the invention can also comprise, in addition, monomers other than those mentioned above.

The base of the impact modifier, optionally known as elastomer base, can be selected from the group consisting of: polyethylenes, polypropylenes, polybutenes, polyisoprenes, ethylene/propylene rubbers (EPR), ethylene/propylene/diene (EPDM) rubbers, ethylene and butene rubbers, ethylene and acrylate rubbers, butadiene and styrene rubbers, butadiene and acrylate rubbers, ethylene and octene rubbers, butadiene acrylonitrile rubbers, ethylene/acrylic acid (EAA) products, ethylene/vinyl acetate (EVA) products, ethylene/acrylic ester (EAE) products, acrylonitrile/butadiene/styrene (ABS) copolymers, styrene/ethylene/butadiene/styrene (SEBS) block copolymers, styrene/butadiene/styrene (SBS) copolymers, core/shell elastomers of methacrylate/butadiene/styrene (MBS) type, or mixtures of at least two elastomers listed above.

In addition to the groups listed above, these impact modifiers can also comprise, generally grafted or copolymerized, functional groups which react with the polyamide, such as, in particular, the following functional groups: acids, such as carboxylic acids, salified acids, esters in particular, acrylates and methacrylates, ionomers, glycidyl groups, in particular epoxy groups, glycidyl esters, anhydrides, in particular maleic anhydrides, oxazolines, maleimides or their mixtures.

Such functional groups on the elastomers are, for example, obtained by use of a comonomer during the preparation of the elastomer.

Mention may in particular be made, as impact modifiers comprising functional groups which react with the polyamide, of terpolymers of ethylene, acrylic ester and glycidyl methacrylate, copolymers of ethylene and of butyl ester acrylate, copolymers of ethylene, n-butyl acrylate and glycidyl methacrylate, copolymers of ethylene and of maleic anhydride, ethylene/propylene/diene copolymers grafted with maleic anhydride, styrene/maleimide copolymers grafted with maleic anhydride, styrene/ethylene/butylene/styrene copolymers modified with maleic anhydride, styrene/acrylonitrile copolymers grafted with maleic anhydrides, acrylonitrile/butadiene/styrene copolymers grafted with maleic anhydrides, and hydrogenated versions thereof.

The weight proportion of the impact modifiers in the total composition is especially between 1% and 25% and preferentially between 5% and 20% relative to the total weight of the composition.

The composition according to the invention may also comprise other additives participating in the thermal stabilization of the composition, such as those chosen from the group comprising: the Cul and KI couple, the CuO/KBr couple, the Cu₂O/KBr couple, hindered phenolic compounds, stabilizers bearing at least one hindered amine unit of HALS type, organic or mineral phosphorus-based stabilizers, such as sodium or manganese hypophosphite, or alternatively compounds comprising at least one polyhydric alcohol comprising from 2 to 8 aliphatic hydroxyl groups, in particular the composition also comprises at least one polyhydric alcohol comprising from 2 to 8 aliphatic hydroxyl groups.

Polyhydric alcohols that may thus be mentioned include those mentioned in the group comprising: diols, such as 1,5-pentanediol, 2,2-dimethyl-1,3-propanediol, triethylene glycol, poly(glycol ether)s, triols, for instance glycerol, trimethylolpropane, 2,3-bis(2′-hydroxyethyl)cyclohexan-1-ol, hexane-1,2,6-triol, 1,1,1-tris(hydroxymethyl)ethane, 3-(2′-hydroxyethoxy)propane-1,2-diol, 3-(2′-hydroxypropoxy)propane-1,2-diol, 2-(2′-hydroxyethoxy)hexane-1,2-diol, 6-(2′-hydroxypropoxy)hexane-1,2-diol, 1,1,1-tris[(2′-hydroxyethoxy)methyl]ethane, 1,1,1-tris[(2′-hydroxypropoxy)methyl]propane, 1,1,1-tris(4′-hydroxyphenyl)ethane, 1,1,1-tris(hydroxyphenyl)propane, 1,1,3-tris(dihydroxy-3-methylphenyl)propane, 1,1,4-tris(dihydroxyphenyl)butane, 1,1,5-tris(hydroxyphenyl)-3-methylpentane, di(trimethylolpropane), trimethylolpropane ethoxylate, or trimethylolpropane propoxylate; polyols, such as pentaerythritol, dipentaerythritol, and tripentaerythritol; and saccharides such as cyclodextrin, D-mannose, glucose, galactose, sucrose, fructose, xylose, arabinose, D-mannitol, D-sorbitol, D- or L-arabitol, xylitol, iditol, talitol, allitol, altritol, gulitol, erythritol, threitol and D-gulonic-γ-lactone; and similar compounds, and in particular the polyhydric alcohol is chosen from polyols such as pentaerythritol, dipentaerythritol and tripentaerythritol.

The content of other additive participating in the thermal stabilization of the composition may range from 0.01% to 5% by weight relative to the total weight of the composition.

The composition according to the invention may also comprise additives normally used in the production of polyamide compositions. Thus, mention may be made of lubricants, flame retardants, plasticizers, nucleating agents, anti-UV agents, catalysts, antioxidants, antistatic agents, dyes, mattifying agents, molding aids or other conventional additives.

These fillers and additives may be added to the modified polyamide by normal means suited to each filler or additive, for instance during the polymerization or by melt blending.

The polyamide compositions are generally obtained by blending the various compounds participating in the composition without heating or in the melt. The process is performed at more or less high temperature and at more or less high shear force, according to the nature of the various compounds. The compounds can be introduced simultaneously or successively. Use is generally made of an extrusion device in which the material is heated, then melted and subjected to a shear force, and conveyed.

It is possible to blend all the compounds in the molten phase during a single operation, for example during an extrusion operation. It is possible, for example, to blend granules of the polymer materials, to introduce them into the extrusion device in order to melt them and to subject them to more or less high shearing. According to specific embodiments, it is possible to preblend some of the compounds, in the melt or not in the melt, before preparation of the final composition.

Polyamide compositions comprising at least one polyamide chain-extending compound and from 1% to 60% by weight of reinforcing or bulking fillers, and from 1% to 25% by weight of impact modifier, relative to the total weight of the composition, are especially preferred.

More specifically, the polyamide composition may comprise from 0.01% to 5% by weight of polyamide chain-extending compound, from 5% to 20% by weight of reinforcing or bulking fillers, and from 5% to 20% by weight of impact modifier, relative to the total weight of the composition.

According to one embodiment, the composition comprises, or even consists of:
polyamide, in particular PA6, PA66, PA610 and/or PA66/6T, especially in a content ranging from 30% to 80% by weight relative to the total weight of the composition,
chain extender, in particular comprising a bis-epoxide, optionally in combination with an organic phosphite, in particular the content of chain extender is greater than 1% by weight relative to the weight of the polyamide,
optionally reinforcing fillers, in particular glass fibers, especially in a content ranging from 10% to 40% by weight relative to the total weight of the composition,
optionally an impact modifier, in particular comprising functional groups that are reactive with the polyamide, especially in a content ranging from 5% to 20% by weight relative to the total weight of the composition,
optionally another additive participating in the thermal stabilization of the composition, in particular a polyhydric alcohol or a Cul/KI, CuO/KBr or Cu₂O/KBr couple, especially in a content ranging from 0.01% to 5% by weight relative to the total weight of the composition, and
optionally at least one additive chosen from lubricants, fire retardants, plasticizers, nucleating agents, anti-UV agents, catalysts, antioxidants, antistatic agents, dyes, mattifying agents and mold-release agents, especially in a content ranging from 0.01% to 8% by weight relative to the total weight of the composition.

The composition according to the invention, when it is prepared using an extrusion device, is preferably conditioned in the form of granules. The granules are intended to be formed using processes involving melting in order to obtain articles. The articles are thus constituted of the composition. According to a normal embodiment, the modified polyamide is extruded in the form of rods, for example in a twin-screw extrusion device, which are then chopped into granules. The molded parts are subsequently prepared by melting the granules produced above and feeding the molten composition into forming devices, particularly injection-molding devices.

The composition according to the invention may be used for any process for forming plastics, for instance the molding process, in particular injection molding, extrusion, extrusion blow-molding or rotary molding. The extrusion process may especially be a spinning process or a process for manufacturing films.

The present invention also relates to the manufacture of articles of impregnated fabric type or composite articles containing continuous fibers. These articles may especially be manufactured by placing in contact a fabric and the polyamide composition according to the invention in the solid or molten state. Fabrics are textile surfaces obtained by assembling yarns or fibers which are rendered integral by any process, especially such as adhesive bonding, felting, braiding, weaving or knitting. These fabrics are also referred to as fibrous or filamentous networks, for example based on glass fiber, carbon fiber or the like. Their structure may be random, unidirectional (1D) or multidirectional (2D, 2.5D, 3D or other).

The present invention also relates to articles obtained by forming the composition according to the invention, for example by extrusion, molding, or injection molding. Mention may be made, as articles, of those used in the motor vehicle industry or the electronics and electrical industry, for example.

The present invention also relates to articles made for applications exposed to high temperatures, especially temperatures of greater than or equal to 80° C., more particularly temperatures of greater than or equal to 150° C. and more specifically temperatures of greater than or equal to 210° C., obtained by forming a composition according to the invention.

The expression “articles made for applications exposed to high temperatures, especially temperatures of greater than or equal to 80° C.” generally means articles manufactured to contain or transport fluids, i.e. liquids or gases, brought to high temperatures, for instance articles of the cooling circuit of a motor vehicle which are intended to keep the engine at an optimum and virtually constant temperature of about 100° C. These articles according to the present invention are thus defined by their applications which expose them to high temperatures; this involving their design, manufacture and intended uses based on this technical constraint in a usual mode of functioning.

As articles subjected to high temperatures, examples that may be mentioned include the articles of the water/glycol cooling circuit, for example the radiator tank, the transfer pipe, the thermostatic tank, the degassing tank, the radiator, articles of the air circuit, for instance the turbo pipe, the air/air exchanger (intercooler), the air inlet or outlet box of the turbo cooler, the exhaust gas recycling circuit, the air intake collector and the associated pipework, the catalytic converter, the parts of the engine-fan group, the intermediate coolers, and the articles of the oil circuit, such as the cylinder head cover, the oil sump, the oil filtration unit, the distribution sump and the oil-transporting assembly pipework. These articles are well known in the field of engine-driven vehicles such as motor vehicles.

Specific terms are used in the description so as to facilitate understanding of the principle of the invention. Nevertheless, it should be understood that no limitation on the scope of the invention is envisioned by the use of these specific terms. The term “and/or” includes the meanings and, or and all the other possible combinations of the elements connected to this term.

Other details or advantages of the invention will become more clearly apparent in the light of the examples below, given solely by way of indication.

### Experimental Part

Before extrusion, polyamide 66 granules with a VI of 153 ml/g (viscosity index in solution of the polyamide in formic acid (VI in mL/g) according to standard ISO 307) are dried to a water content of less than 1000 ppm. Formulations are prepared by melt-blending various components and additives in a Werner & Pfleiderer ZSK 40 twin-screw corotating extruder operating at 40 kg/h and at a speed of 230-250 rpm. The temperature settings in the 8 zones are respectively: 245, 245, 245, 250, 255, 260, 260, 265° C. All the components in the formulation are added at the start of the extruder. The rod having exited the extruder is cooled in a water tank and cut into the form of granules using a granulator and the granules are packaged in a heat-sealed bag. Before being injection molded, the granules are dried so as to obtain a moisture content of less than 1000 ppm.

The additives used are as follows:
1.5% by weight of chain-extending compound: Araldite® GT7071 (Huntsman)
15% by weight of impact modifier: Exxelor VA1801 (ethylenic copolymer grafted with maleic anhydride)
0.2% by weight of Cul and KI from Ajay Europe
15% by weight of OCV 983 glass fiber from Owens Corning Vetrotex the weight percentages are expressed by weight relative to the total weight of the composition.

The prepared formulations are injected onto a Demag 50T press at 280-300° C. with a mold temperature of 80° C., in the form of multifunction specimens 4 mm thick, to characterize the traction and tensile mechanical properties (mean obtained on five samples) according to standard ISO 527/1A before and after thermal aging in air.

The air-ventilated thermal aging is performed by placing the specimens in a Heraeus TK62120 oven regulated at the chosen temperature. At different aging times, specimens are removed from the oven, cooled to room temperature and placed in heat-sealed bags to prevent them from taking up moisture before evaluation of their mechanical properties.

The retention of breaking stress or of impact strength at a given aging time is then defined relative to these same properties before aging. The retention is thus defined as a percentage.

The properties of the polyamide composition are collated in tables 1 and 2 below:

TABLE 1

| | | After aging | After aging | After aging |
|---|---|---|---|---|
| | | 1000 h | 700 h | 1000 h |
| Properties | Before aging | 150° C. | 210° C. | 210° C. |
| Flexural | 4820 | 4910 | 5230 | 5300 |
| modulus | | | | |
| (MPa) | | | | |
| Maximum | 157.5 | 153.9 | 116.2 | 105.5 |
| flexural stress | | | | |
| (MPa) | | | | |
| Flexural strain | 4.6 | 3.81 | 2.4 | 2.19 |
| (%) | | | | |

TABLE 2

| | | Traction: | |
|---|---|---|---|
| | Traction: | breaking | Traction: |
| | modulus | stress | strain |
| Properties | (MPa) | (MPa) | (%) |
| Before aging | 4773 | 92.5 (100%) | 3.56 |
| After aging | 5110 | 82.5 (89%) | 1.9 |
| 2000 h | | | |
| 150° C. | | | |
| After aging | 4708 | 67.5 (73%) | 1.55 |
| 1000 h | | | |
| 190° C. | | | |
| After aging | 5998 | 67 (72%) | 1.44 |
| 1000 h | | | |
| 210° C. | | | |
| After aging | 5360 | 59.3 (64%) | 1.21 |
| 2000 h | | | |
| 220° C. | | | |
| After aging | 4707 | 61 (65%) | 1.39 |
| 1000 h | | | |
| 230° C. | | | |
| After aging | 4784 | 63.6 (68%) | 1.45 |
| 1000 h | | | |
| 240° C. | | | |

It is thus observed that the addition of the compound according to the invention to the polyamide allows noteworthy retention of the mechanical properties both in traction and tension, where standard compositions would have shown a dramatic drop in these properties.

The composition according to the invention thus shows retention of the tensile breaking stress of greater than or equal to 50%, measured according to standard ISO 527/1A on specimens 4 mm thick after an aging test in air at 210° C. for 1000 hours, in comparison with the same composition before the aging test.

1. A method for stabilizing the a polyamide composition toward heat, light and/or bad weather, comprising combining at least a polyamide and a polyamide chain extending agent to form the polyamide composition.

2. The method of claim 1, the polyamide composition has a retention of the tensile breaking stress of greater than or equal to 50%, measured according to standard ISO 527/1A on specimens 4 mm thick after an aging test in air at 210° C. for 1000 hours, in comparison with the same composition before the aging test.

3. The method of claim 1, wherein the polyamide chain-extending compound is chosen from the group consisting of: dialcohols, bis-epoxides, polymers bearing epoxide functions, polymers bearing anhydride functions, bis-N-acyl bis-caprolactams, diphenyl carbonates, bisoxazolines, oxazolinones, diisocyanates, organic phosphites, bis-ketenimines and dianhydrides.

4. The method of claims 1 wherein the polyamide composition comprises from 0.01% to 5% by weight of polyamide chain-extending compound relative to the total weight of the polyamide composition.

5. The method of claim 1 wherein the polyamide is chosen from the group comprising: polyamide 6, polyamide 610, polyamide 66, and polyamide 66/6T.

6. The method of claims 1 wherein the polyamide composition further comprises at least one reinforcing or bulking filler.

7. The use method of claims 1 wherein the polyamide composition further comprises at least one impact modifier.

8. The use method of claims 1 wherein the polyamide composition further comprises at least one other additive participating in the thermal stabilization of the composition.

9. An article comprising a stabilized polyamide composition made by the method of claim 1, wherein the article is made for applications exposed to temperatures of greater than or equal to 80° C.

10. The article as claimed in claim 9, wherein the article is manufactured to contain or transport fluids.

11. A method for stabilizing a polyamide composition toward heat, light, and/or bad weather, comprising combining one or more polyamide chain extending agents that comprise at least a bisphenol A diglycidal ether chain extending agent with polyamide 66, an impact modifier, Cul, KI, and reinforcing glass fibers, to form the polyamide composition, wherein the stabilized polyamide composition exhibits a retention of the tensile breaking stress of greater than or equal to 50%, measured according to standard ISO 527/1A on specimens 4 mm thick after an aging test in air at 210° C. for 1000 hours, in comparison with the same composition before the aging test.
